(19) United States
(12) Patent Application Publication
(10) Pub. No.: US 2024/0026700 A1
(43) Pub. Date: Jan. 25, 2024

(54) EQUIPMENT FOR SWIMMING POOLS AND SPAS WITH NEAR-FIELD COMMUNICATION

(71) Applicant: ZODIAC POOL SYSTEMS LLC, Carlsbad, CA (US)

(72) Inventors: Mark Bauckman, San Marcos, CA (US); Hwa Heng, Carlsbad, CA (US); Barton Lu, Shanghai (CN); Jared Leander, Carlsbad, CA (US); Arnaud Besnier, Beaupuy (FR); Mehdi Chafik, Tournefeuille (FR)

(73) Assignee: ZODIAC POOL SYSTEMS LLC, Carlsbad, CA (US)

(21) Appl. No.: 18/223,851

(22) Filed: Jul. 19, 2023

Related U.S. Application Data
(60) Provisional application No. 63/390,880, filed on Jul. 20, 2022.

(51) Int. Cl. E04H 4/12; E04H 4/14; E04H 4/16; H04B 5/00; H05B 47/19

(52) U.S. Cl. CPC E04H 4/12; E04H 4/148; E04H 4/1654; H04B 5/0043; H05B 47/19

(57) ABSTRACT

Pool equipment for swimming pools and spas may include pumps, heaters, filters, pool lights, sensors, automatic pool cleaners, and/or other pieces of equipment. Such pool equipment may include a near-field communication chip, and near-field communication may be used to send information to the pool equipment (including energizing the pool equipment) and/or to receive information from the pool equipment.

### REFERENCE TO RELATED APPLICATION

This application claims the benefit of U.S. Provisional Patent Application No. 63/390,880, filed on Jul. 20, 2022, and entitled EQUIPMENT FOR SWIMMING POOLS AND SPAS WITH NEAR-FIELD COMMUNICATION, the content of which is hereby incorporated by reference in its entirety.

### FIELD OF THE INVENTION

This invention relates to equipment for swimming pools and spas, and more particularly, to equipment for swimming pools and spas with improved communication.

### BACKGROUND OF THE INVENTION

Equipment for pools or spas such as pumps, filters, lights, heaters, and automatic swimming pool cleaners (APCs), among others, may need to be provided information (e.g., configurations, settings, etc.) and/or information (e.g., current configuration, last configuration, operational data, etc.) may need to be obtained from such equipment. Existing techniques for providing information to and/or obtaining information from pool equipment require the pool equipment to have power or require a memory element to be removed from the pool equipment. Such techniques only provide limited communication, and information cannot be provided or obtained in many situations such as during a new pool installation (when equipment may be installed prior to the site having power), when the equipment is not powered on, and/or when the equipment is damaged, failed, and/or otherwise not functional. Existing techniques also commonly require a physical connection with the pool equipment and utilize a plug, but such physical connections create potential leak paths.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method of communicating with equipment for a swimming pool or spa includes using near-field communications (NFC) to communicate with the equipment.

According to various embodiments, equipment for a swimming pool or spa may communicate with another device using NFC.

According to some embodiments, equipment for a swimming pool or spa includes an NFC chip, an antenna for the NFC chip, a driver circuit board, and a light source circuit board.

According to certain embodiments, equipment for a swimming pool or spa includes an NFC chip, an antenna for the NFC chip, and a circuit board. In some embodiments, the NFC chip and the antenna are both on the circuit board.

According to various embodiments, a method of communicating with equipment for a swimming pool or spa includes receiving data from or sending data to the equipment while the equipment is not powered and/or not functional.

According to certain embodiments, a method of installing equipment for a swimming pool or spa includes un-packaging the equipment and setting an initial setting for the equipment using NFC.

According to some embodiments, a method of controlling equipment for a swimming pool or spa includes changing a setting or reading data from the equipment using NFC.

According to certain embodiments, a method of performing diagnostics on equipment for a swimming pool or spa includes reading an error code or other information from the equipment using NFC.

According some various embodiments, an APC for a swimming pool or spa is configured for NFC.

According to various embodiments, a method of communicating with an APC for a swimming pool or spa includes communicating with the APC using NFC.

According to certain embodiments, an APC for a swimming pool or spa includes means for communicating via NFC.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an example of a pool system having at least one piece of equipment with NFC communication according to various embodiments.

FIG. 2 illustrates the pool system of FIG. 1 according to embodiments.

FIG. 3 illustrates the pool system of FIG. 1 according to embodiments.

FIGS. 4A-C illustrate examples of the at least one piece of equipment of FIG. 1 according to embodiments.

FIGS. 5A-D illustrate examples of the at least one piece of equipment of FIG. 1 according to embodiments.

FIG. 6 illustrates the pool system of FIG. 1 according to embodiments.

FIG. 7 illustrates an example of the at least one piece of equipment of FIG. 1 according to embodiments.

FIG. 8 illustrates the pool system of FIG. 1 according to embodiments.

### DETAILED DESCRIPTION

Described herein are systems and methods for communicating with pool equipment such as pool lights, pumps, APCs, etc. without having a wired connection to the pool equipment. According to various embodiments, the systems and methods described herein allow for contactless communication (e.g., sending and/or receiving data without requiring a physical connection with the equipment) with the pool equipment such as to configure the pool equipment, perform diagnostics on the pool equipment, upload firmware, modifying EEPROM and/or other memory parameters, and/or as otherwise desired. In certain embodiments, the systems and methods described herein allow for communication with the pool equipment without powering the pool equipment and/or while the pool equipment is not functional or operational. In some embodiments, the communication is a self-powered communication. According to certain embodiments, pool equipment includes a near-field communication (NFC) chip, and the pool equipment may communicate via NFC. The systems and methods described herein may allow for a user to communicate with the pool equipment, including during testing, development, and/or to connect the pool equipment with an application. Pool equipment described herein may easily be set or changed to a desired setting compared to the labor-intensive traditional techniques of manual setting while the pool equipment is powered.

In certain embodiments, pool equipment provided herein may have improved arrangements of an NFC chip and associated antenna such as to be proximate to access areas and/or not obstructed by metal.

Methods of communicating with pool equipment having NFC may include, but are not limited to, energizing the pool equipment, selecting a run program (e.g., a color program for pool lights), setting configuration data (e.g., setting configuration data on pool lights to have “zones” which allow lights or groups of lights to behave differently based on input), setting device address or name to facilitate setup, reading device address to assist with pairing a user device, managing communication, and/or extracting performance or operational data (e.g., run time hours, temperature, voltage current, etc.). Various other benefits and advantages may be realized with the systems, devices, and methods provided herein, and the aforementioned advantages should not be considered limiting.

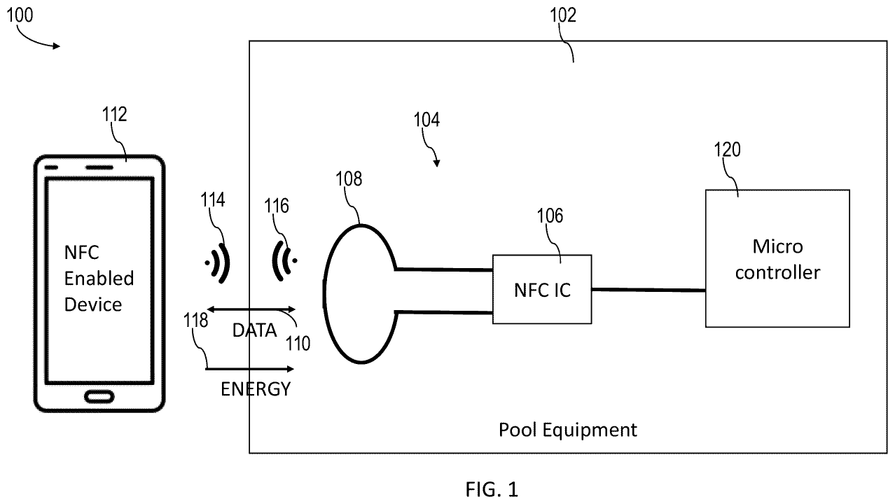

FIG. 1 illustrates an example of a pool system 100 according to various embodiments. The pool system 100 includes at least one piece of pool equipment 102 for a swimming pool or spa. The pool equipment 102 may be various types of pool equipment as desired, including but not limited to heaters, pumps, filters, lights, APCs, combinations thereof, and/or other types of pool equipment as desired. In some embodiments, the pool equipment 102 (e.g., pool lights) is configured to be submerged in water of the swimming pool or spa when installed, although the equipment 102 need not be submerged equipment in other embodiments.

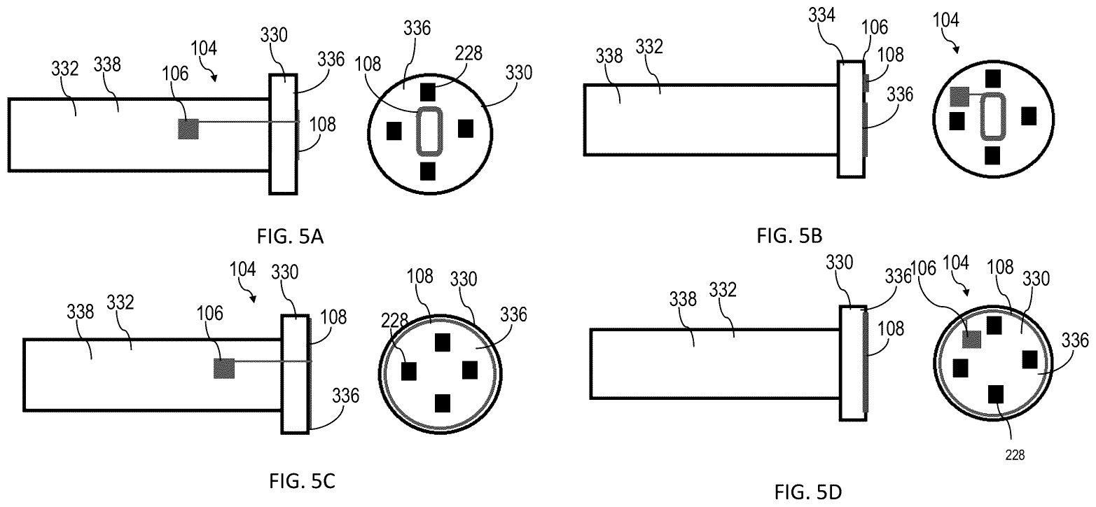

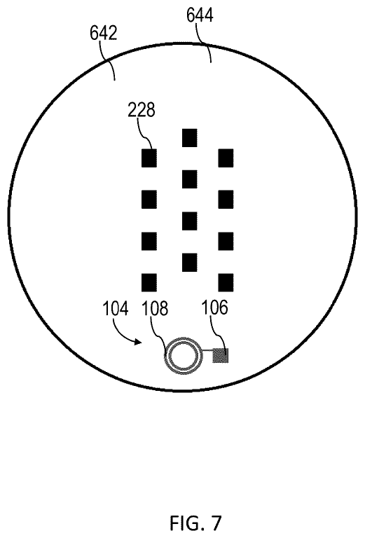

As illustrated in FIG. 1, the pool equipment 102 includes an NFC module 104 having an NFC chip 106 and an associated antenna 108 and controller 120 (e.g., processor and/or memory). The antenna 108 may be various suitable antennas for NFC communication, and in one non-limiting embodiment, the antenna 108 is a copper coil. The antenna 108 may have various shapes or configurations as desired. As non-limiting examples, FIG. 5A illustrates an antenna 108 that is coiled relatively compactly, FIG. 5C illustrates an antenna 108 having a relatively increased diameter compared to FIG. 5A, and FIG. 7 illustrates the antenna 108 at a location that is not centered compared to FIG. 5A. The pool equipment 102 may be provided with one or more circuit boards, and as discussed in detail below, the antenna 108 and NFC chip 106 may be provided at various locations on or within the pool equipment 102 on the one or more circuit boards as desired.

The NFC module 104 enables short-range, wireless (e.g., contactless) communication 110 of data between the pool equipment 102 and another NFC-enabled device 112. The NFC-enabled device 112 may be a personal electronic device such as a smartphone of a user or technician, or any other NFC-enabled device 112 as desired. In some embodiments, another NFC-enabled device 112 may be another piece of pool equipment 102 such as a pool cleaner, a pump, a sensor, a filter, a heater, a light, combinations thereof, and/or other equipment as desired. Communication 110 may be control information 114 provided to the pool equipment 102 (e.g., operation modes, settings, etc.) and/or read information 116 obtained from the pool equipment 102 (e.g., current settings, error codes, identifications, operational information, manufacturing data, etc.).

In certain embodiments, the NFC module 104 is a passive device that is powered wirelessly 118 by the NFC-enabled device 112 (e.g., by a magnetic field generated by the NFC-enabled device 112). In this manner, the control information 114 may be provided to the pool equipment 102 and/or the read information 116 may be obtained from the pool equipment while the overall equipment 102 is not powered, not functional, not operational, etc.

The controller 120 may be various suitable processor and/or memory devices as desired. In certain embodiments, the controller 120 may be communicatively coupled with other components of the pool equipment 102 such that the control information 114 received via NFC may be provided to control such components. The controller 120 communicatively coupled with other components of the pool equipment 102 also allows for the other components to provide information about the pool equipment 102 to the controller 120 that the NFC-enabled device 112 can obtain as the read information 116. In some embodiments, the controller 120 may at least temporarily store an amount of information from the pool equipment 102 (e.g., last operational settings of the pool equipment 102, last three error codes from the pool equipment 102, etc.) such that the read information 116 may be obtained from the pool equipment 102 without the pool equipment being operational or powered. Similarly, the controller 120 may at least temporarily store the control information 114 from the NFC-enabled device 112 such that control information can be received by the pool equipment 102 without the pool equipment being operational or powered. In such embodiments, the control information 114 may be communicated to the other components of the pool equipment 102 upon the pool equipment 102 being powered, operational, or as otherwise desired.

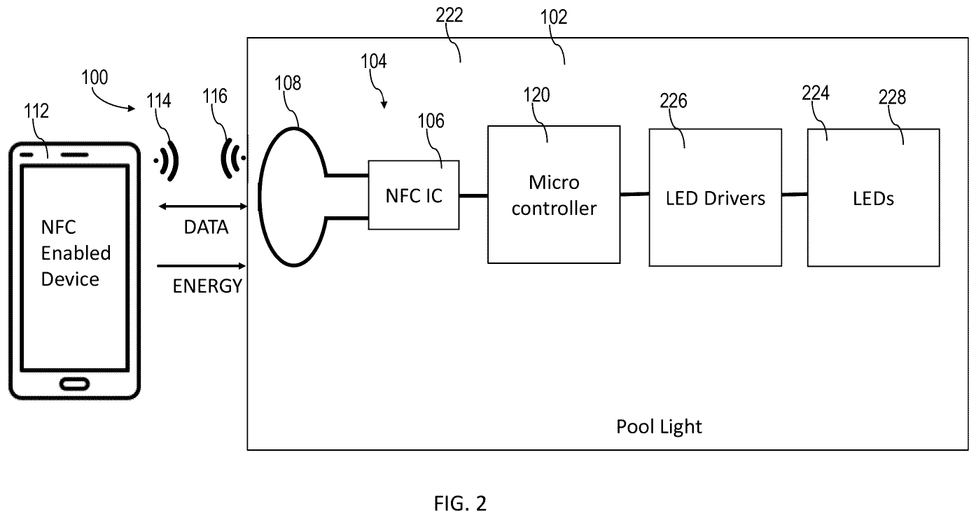

FIG. 2 illustrates an example of the pool system 100 in which the pool equipment 102 is a pool light 222. In this embodiment, the pool light 222 includes one or more light sources 224 and a driver 226 for controlling the one or more light sources 224. In the embodiment illustrated, the one or more light sources 224 are one or more light emitting diodes (LEDs) 228. As illustrated in FIG. 2, the controller 120 may be communicatively coupled with the driver 226 such that the control information 114 may be provided to the driver 226 for controlling the light sources 224 and/or such that information about the light sources 224 and/or the driver 226 may be provided to the NFC-enabled device 112 as the read information 116.

As mentioned, pool equipment 102 may be provided with one or more circuit boards, and the components of the NFC module 104 may be provided at various locations on the one or more circuit boards as desired. In various embodiments, at least the antenna 108 may be provided at a location such that the NFC chip 106 can be powered wirelessly 118 and communicate with the NFC-enabled device 112. As non-limiting examples, the antenna 108 may be provided on a front circuit board of the pool equipment 102, a housing of the pool equipment 102 may include a cutout region if the antenna 108 is provided on a back circuit board, and/or at least a portion of the housing of the pool equipment 102 may be non-metallic such that signals can be sent to and from the antenna 108.

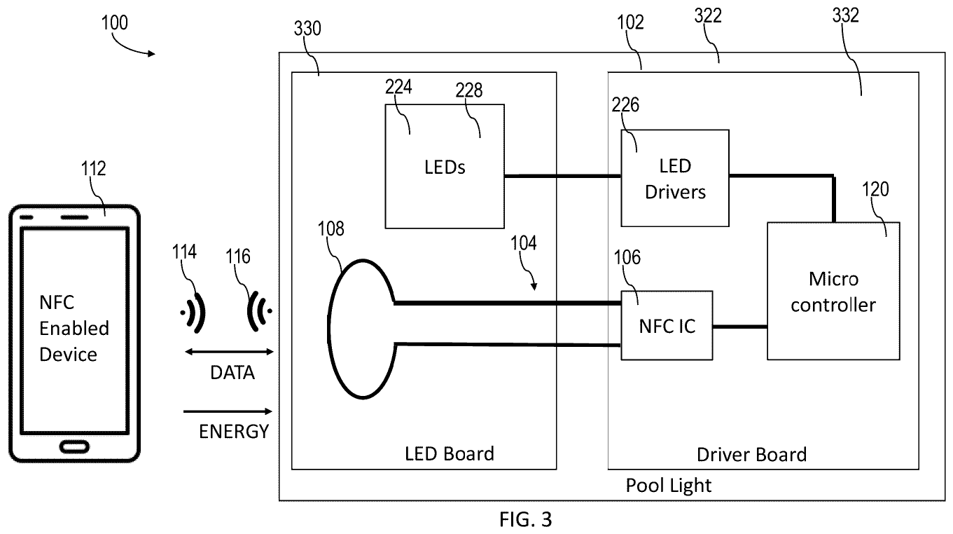

FIGS. 3-7 illustrate non-limiting examples of various configurations of the NFC module 104 for the pool equipment 102. In these embodiments, the pool equipment 102 is illustrated as pool lights. However, the configurations illustrated in FIGS. 3-7 should not be considered limiting, and the pool equipment 102 may be pool equipment other than pool lights. Moreover, the configuration of the NFC module 104 on a first piece of pool equipment for the swimming pool or spa need not be the same as the configuration of the NFC module 104 on a second piece of pool equipment for the swimming pool or spa.

FIG. 3 illustrates an example of the pool system 100 with a pool light 322 as the pool equipment 102 according to various embodiments. In this embodiment, the pool light 322 optionally is a nicheless pool light 322. The pool light 322 generally includes a first (or front) circuit board 330 and a second (or back) circuit board 332. In the embodiments illustrated, the first circuit board 330 may be a light source circuit board for supporting the one or more light sources 224 proximate to a lens or optic of the pool light 322, and the circuit board 332 may be a driver circuit board for supporting the driver 226. In the embodiment of FIG. 3, the antenna 108 is provided on the first circuit board 330 and the NFC chip 106 and the controller 120 are provided on the second circuit board 332. In this embodiment, the antenna 108 is provided proximate to a front of the pool light 322, which may facilitate NFC communication with the NFC-enabled device 112.

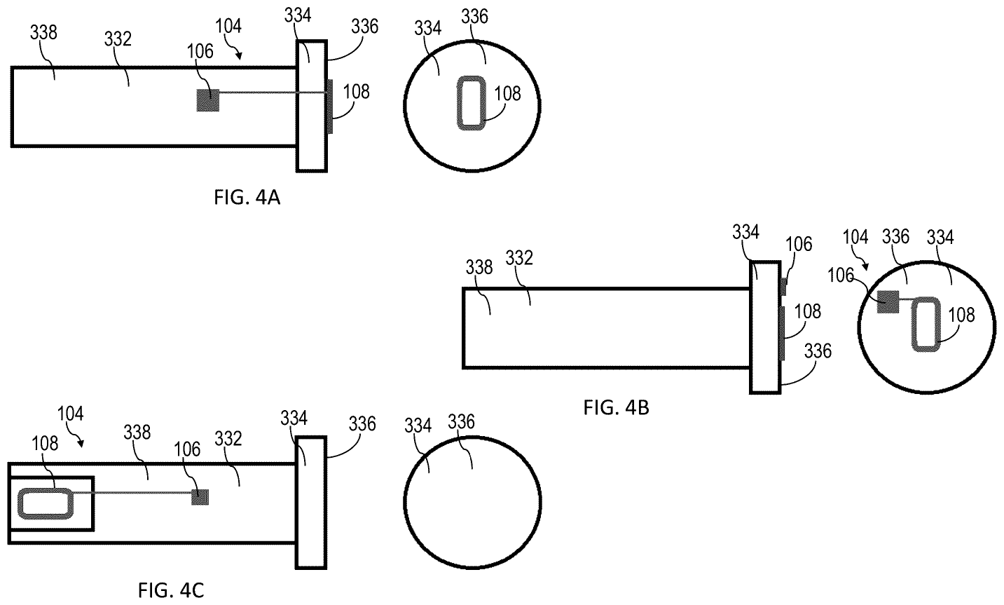

FIGS. 4A-C illustrate additional non-limiting examples of configurations of the NFC module 104 when the pool light 322 (or other pool equipment 102) includes the circuit boards 330, 332.

In FIG. 4A, the NFC chip 106 is provided on the second circuit board 332 and the antenna 108 is provided on the first circuit board 330. In the embodiment of FIG. 4A, the NFC chip 106 is provided on a side or face 338 of the second circuit board 332 and the antenna 108 is provided on a side or face 336 of the first circuit board 330 that is not parallel to the face 338.

In FIG. 4B, both the NFC chip 106 and the antenna 108 are provided on the face 336 of the first circuit board 330.

In FIG. 4C, the NFC chip 106 and the antenna 108 are both provided on the face 338 of the second circuit board 332. The particular locations of the antenna 108 and/or the NFC chip 106 on the circuit boards 330, 332 should not be considered limiting. As an example, while the antenna 108 is illustrated as centered on the first circuit board 330 in FIGS. 4A-B, it need not be centered in other embodiments.

FIGS. 5A-D illustrate additional non-limiting examples of configurations of the NFC module 104 when the pool light 322 (or other pool equipment 102) includes the circuit boards 330, 332.

FIG. 5A is substantially similar to FIG. 4A and additionally illustrates a plurality of LEDs 228 on the face 336 of the first circuit board 330. The number and arrangement of the LEDs 228 on the first circuitry board 330 and relative to the antenna 108 should not be considered limiting. In the embodiment of FIG. 5A, the antenna 108 is centered on the first circuit board 330 and is surrounded by the LEDs 228.

FIG. 5B is substantially similar to FIG. 4B and additionally illustrates the plurality of LEDs 228 on the face 336 of the first circuit board 330. In the embodiment of FIG. 5A, the antenna 108 is centered on the first circuit board 330 and is surrounded by the LEDs 228, and the NFC chip 106 is provided at an offset location relative to the antenna 108 and the LEDs 228.

FIG. 5C illustrates an arrangement that is substantially similar to FIG. 5A except that the antenna 108 in FIG. 5C is provided along a perimeter 540 of the face 336 and the antenna 108 encompasses the LEDs 228.

FIG. 5D illustrates an arrangement that is substantially similar to FIG. 5B except that the antenna 108 in FIG. 5D is provided along the perimeter 540 of the face 336 and the antenna 108 encompasses both the NFC chip 106 and the LEDs 228.

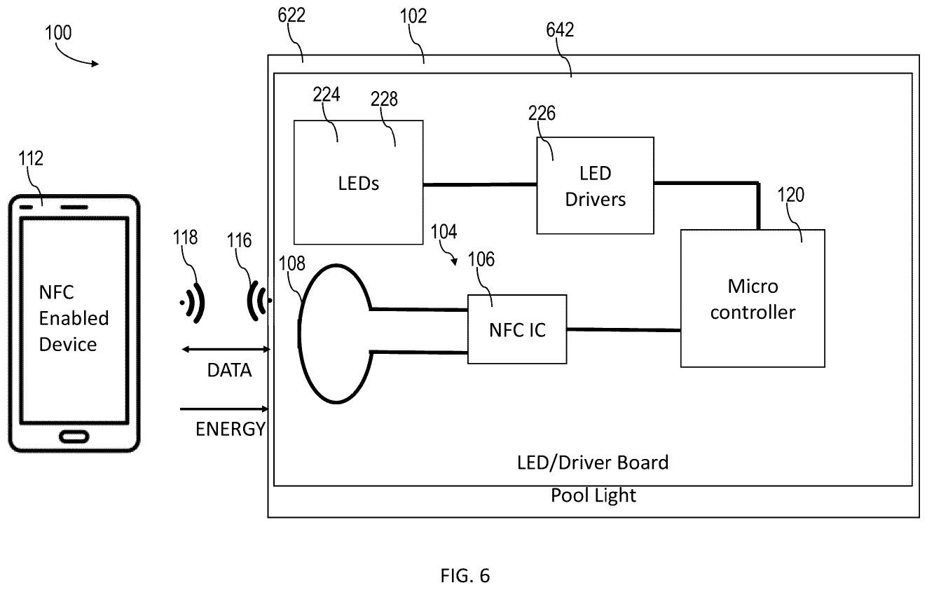

FIGS. 6 and 7 illustrate an example of the pool system 100 with a pool light 622 as the pool equipment 102 according to various embodiments. In this embodiment, the pool light 622 optionally is a nicheless pool light 622. Compared to the pool light 322, the pool light 622 includes a single circuit board 642 for supporting both the light sources 224 and the driver 226 of the pool light 622.

In this embodiment, the NFC chip 106 and antenna 108 both may be provided on the circuit board 642. The NFC chip 106 and the antenna 108 may be provided at various locations as desired, such as but not limited to various locations on a side or face 644 of the circuit board 642 for positioning of the NFC chip 106 and antenna 108 proximate to a lens or optic of the pool light 622. As one non-limiting example, FIG. 7 illustrates the antenna 108 and the NFC chip 106 on the face 644, and the antenna 108 and the NFC chip 106 are not centered on the face 644 and/or relative to the LEDs 228. In this embodiment, the positioning of the antenna 108 off-center may minimize obstruction of light emitted by the light sources 224.

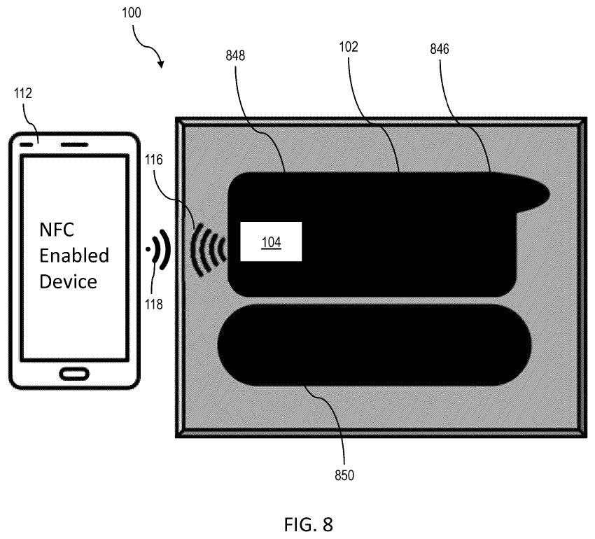

FIG. 8 illustrates an example of the pool system 100 with an APC 846 as the pool equipment 102 according to various embodiments. In FIG. 8, the APC 846 generally includes a body 848 and one or more motive elements 850 (e.g., wheels, tracks, etc.). The APC 846 may include one or more inlets and one or more outlets, and water may be pulled into the APC 846 via the one or more inlets, through the APC 846 (e.g., through a filter), and out the one or more outlets. The APC 846 may include a pump, filter assembly, cleaning device such as a brush assembly or other suitable device, any suitable electric or other motors, a controller (e.g., processor and memory), a communication module, and/or an on-board power source (e.g., rechargeable batteries). The particular APC 846 illustrated in FIG. 8 should not be considered limiting, and in other embodiments, other types of APCs may be used with fewer, additional, and/or different combinations or types of features as desired. For example, the APC need not have an on-board power source and instead may receive power from an external power source via a cord or otherwise. As non-limiting examples, the APC 846 may be various types of cleaning devices capable of autonomous movement within swimming pools and spas as desired, such as hydraulic or robotic APCs 846. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. In embodiments wherein the pool equipment 102 is the APC 846, the NFC module 104 optionally may include an integrated antenna within a body of the APC 846 as well as an external antenna. In some embodiments where the APC 846 is battery-powered, NFC may be used to activate/turn on the electronics get the battery powering the system, among other possible controls. In some embodiments wherein the APC 846 is corded, NFC may be used to energize the system to manage communication, among other possible controls.

The APC 846 with the NFC module 104 may allow for communication between the NFC-enabled device 112 and the APC 846 without requiring a physical connection and without powering on the APC 846 as desired. As a non-limiting example, the NFC-enabled device 112 may communicate with the APC 846 while the APC 846 is packaged within packaging (e.g., after being bought) to provide settings to the APC 846 and/or obtain information from the APC 846. NFC communication with the APC 846 may be used during other stages of use of the APC 846, such as but not limited to during production (e.g., for testing purposes), for diagnostic purposes (how many cleaning cycles have been performed), to wake up the APC 846 from a low-powered state to an energized state, for control purposes, etc. As another example, NFC communication may allow a user to select a desired cleaning mode for the APC 846 from a plurality of cleaning modes (e.g., pool-cleaning mode, spa-cleaning mode, fountain-cleaning mode, etc.). The cleaning mode may be selected as part of set-up process for the APC and once the particular cleaning mode is selected, the cleaning mode may not need to be selected again unless a different desired cleaning mode is desired.

Various methods may be used to communicate with the pool equipment 102 having the NFC module 104, such as but not limited to changing a setting on the pool equipment 102, setting up the pool equipment 102 during installation, energizing the pool equipment 102, controlling the pool equipment 102, obtaining operational data from the pool equipment 102, obtaining error codes and/or diagnostic data from the pool equipment 102, combinations thereof, and/or other processes as desired. As a non-limiting example, when the pool equipment is a pool light such as the pool light 222, NFC may be used to obtain the information 116 such as power usage, current color mode, current light program, temperature, and/or other information as desired. Similarly, NFC may be used to provide the control information 114 such as a desired color mode, a desired light program, and/or as other information as desired. In various embodiments, NFC communication may be used to recognize and/or pair pool equipment 102 with particular users and/or vice versa. As an example, an RFID subsystem of the pool equipment 102 may be automatically recognized, and the pool equipment 102 may be paired with a user device based on an identification, recognition, and/or otherwise as desired.

Referring back to FIG. 2, as one non-limiting example, the pool light 222 with the NFC module 104 may be set up to have a particular color mode during installation of the pool light 222. In this example, a user of the NFC-enabled device 112 may use the NFC-enabled device 112 to obtain the current color mode as the read information 116 regardless of whether the pool light 222 is powered, functional, and/or operational. In other embodiments, the user need not obtain the current color mode to set a desired color mode. Optionally, the user may set a desired color mode for the pool light 222 on an application (“app”) running on the NFC-enabled device 112, and the NFC-enabled device 112 provides the color mode to the NFC module 104 as the control information 114. In some embodiments, the color mode as the control information 114 may be provided before the pool light 222 is installed in a particular location. In these embodiments, when the pool light 222 is powered, the pool light 222 will be set to be at the desired color mode based on the control information 114.

As another non-limiting example, pool equipment 102 with the NFC modules 104 may be addressed or assigned a unique identification before powering the pool equipment or otherwise completing installation. As an example, a user may know where a piece of pool equipment (e.g., a pump) is physically plumbed, and the user may use the NFC-enabled device 112 to name the pump as “Pump #1”. Additionally or alternatively, the user may use the NFC-enabled device 112 to identify a piece of pool equipment without previously knowing such information. As an example, a pool system may have ten pumps, and the user may know that “Pump #2” needs maintenance but not know which of the ten pumps “Pump #2” is. In this embodiment, the NFC communication allows the user to quickly identify the equipment.

As a further non-limiting example, NFC may be used to select a run program for pool equipment such as pool lights. As an example, pool lighting may have multiple programs defining color, color sequences, zones, etc. NFC may be used to set configuration data on lights to behave in various manners based on the input. As another example, NFC may be used to configure zones of pool lights to allow lights or groups of lights to behave differently based on input.

As yet another example, diagnostics may easily be performed on pool equipment 102 with an NFC module 104. As an example, on a failed or damaged piece of pool equipment 102, operational data (error codes, run time hours, temperature, voltage current, etc.) may still be retrievable if the NFC chip 106 and antenna 108 are operational.

Various other applications and methods of communicating with pool equipment using NFC may be used as desired.

Exemplary concepts or combinations of features of the invention may include:
A. A method of communicating with equipment for a swimming pool or spa, the method comprising using NFC to communicate with the equipment.
B. The method according to any preceding or subsequent statement or combination of statements, wherein the equipment comprises a pump, a pool light, an APC, and/or a sensor for the swimming pool or spa.
C. The method according to any preceding or subsequent statement or combination of statements, wherein the equipment is a pool light, and wherein the method comprises using NFC to set a color mode on the pool light.
D. Equipment for a swimming pool or spa, the equipment configured to communicate with another device using near-field communication.
E. The equipment according to any preceding or subsequent statement or combination of statements, wherein the equipment comprises a pump, a pool light, and/or a sensor for the swimming pool or spa.
F. The equipment according to any preceding or subsequent statement or combination of statements, wherein the equipment comprises an NFC chip, an antenna for the NFC chip, and a controller communicatively coupled to the NFC chip.
G. The equipment according to any preceding or subsequent statement or combination of statements, wherein the antenna is a copper coil.
H. The equipment according to any preceding or subsequent statement or combination of statements, wherein the equipment comprises a driver board and/or a light source circuit board, and wherein the NFC chip is on the driver board or the light source circuit board.
I. Equipment for a swimming pool or spa, the equipment comprising an NFC chip, an antenna for the NFC chip, a driver circuit board, and a light source circuit board.
J. The equipment according to any preceding or subsequent statement or combination of statements, wherein the NFC chip and the antenna are both on the driver circuit board or are both on the light source circuit board.
K. The equipment according to any preceding or subsequent statement or combination of statements, wherein the NFC chip and the antenna are both on the light source circuit board.
L. The equipment according to any preceding or subsequent statement or combination of statements, wherein the light source circuit board comprises at least one light emitting diode as a light source.
M. The equipment according to any preceding or subsequent statement or combination of statements, wherein the antenna is on the light source circuit board, and wherein the antenna is centered on the light source circuit board or extends along a perimeter of the light source circuit board.
N. The equipment according to any preceding or subsequent statement or combination of statements, wherein the NFC chip and the antenna are on different circuit boards.
O. Equipment for a swimming pool or spa, the equipment comprising an NFC chip, an antenna for the NFC chip, and a circuit board, wherein the NFC chip and the antenna are both on the circuit board.
P. The equipment according to any preceding or subsequent statement or combination of statements, wherein the antenna is centered on the circuit board or extends along a perimeter of the circuit board.
Q. The equipment according to any preceding or subsequent statement or combination of statements, further comprising at least one light emitting diode as a light source on the circuit board.
R. The equipment according to any preceding or subsequent statement or combination of statements, wherein the equipment is configured to be submerged within the swimming pool or spa.
S. A method of communicating with equipment for a swimming pool or spa, the method comprising receiving data from or sending data to the equipment while the equipment is not powered and/or not functional.
T. A method of installing equipment for a swimming pool or spa, the method comprising un-packaging the equipment and setting an initial setting for the equipment using NFC.
U. The method according to any preceding or subsequent statement or combination of statements, further comprising using an application on a user device to set the initial setting.
V. The method according to any preceding or subsequent statement or combination of statements, wherein communicating with the pool light comprises communicating using a piece of pool equipment.
W. The method according to any preceding or subsequent statement or combination of statements, wherein the piece of pool equipment comprises at least one of an APC, a sensor, another pool light, or a pump.
X. A method of controlling equipment for a swimming pool or spa, the method comprising changing a setting or reading data from the equipment using NFC.
Y. The method according to any preceding or subsequent statement or combination of statements, further comprising using an application on a user device to change the setting.
Z. The method according to any preceding or subsequent statement or combination of statements, the method comprising changing the setting or reading data while the equipment is not powered.
AA. A method of performing diagnostics on equipment for a swimming pool or spa, the method comprising reading an error code or other information from the equipment using NFC.
BB. An APC for a swimming pool or spa, the APC configured for NFC.
CC. The APC according to any preceding or subsequent statement or combination of statements, wherein the APC comprises an NFC module comprising an NFC chip.
DD. A method of communicating with an APC for a swimming pool or spa, the method comprising communicating with the APC using NFC.
EE. The method according to any preceding or subsequent statement or combination of statements, wherein communicating with the APC comprises powering the APC, controlling a mode of the APC, or receiving operational information about the APC.
FF. An APC for a swimming pool or spa comprising means for communicating via NFC.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pools and spas, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A method of communicating with equipment for a swimming pool or spa, the method comprising receiving data from or sending data to the equipment for the swimming pool or spa while the equipment is not powered and/or not functional.

2. The method of claim 1, wherein receiving data or sending data comprises using near-field communication.

3. The method of claim 1, wherein the equipment for the swimming pool or spa comprises at least one of a pool light, a pump, an automatic swimming pool cleaner, or a sensor for the swimming pool or spa.

4. The method of claim 1, wherein receiving data from or sending data to the equipment comprises setting an initial setting for the equipment.

5. The method of claim 1, wherein receiving data from or sending data to the equipment comprises changing a setting or reading data from the equipment.

6. The method of claim 1, wherein receiving data from or sending data to the equipment comprises performing diagnostics on the equipment for a swimming pool or spa.

7. The method of claim 1, wherein the equipment is a pool light, and wherein the method comprises using setting a color mode on the pool light.

8. Equipment for a swimming pool or spa includes means for receiving data from or sending data to while the equipment is not powered and/or not functional.

9. The equipment of claim 8, wherein the equipment for the swimming pool or spa comprises at least one of a pool light, a pump, an automatic swimming pool cleaner, or a sensor for the swimming pool or spa.

10. The equipment of claim 8, wherein the equipment is configured to be submerged within the swimming pool or spa.

11. The equipment of claim 8, wherein the equipment comprises a near-field communication chip, an antenna for the near-field communication chip, and a controller communicatively coupled to the near-field communication chip.

12. The equipment of claim 11, further comprising a driver circuit board and a light source circuitry board, wherein the near-field communication chip and the antenna are both on the driver circuit board or are both on the light source circuit board.

13. The equipment of claim 12, further comprising at least one light emitting diode on the light source circuit board.

14. The equipment according claim 11, further comprising a driver circuit board and a light source circuitry board, wherein the antenna is on the light source circuit board, and wherein the antenna is centered on the light source circuit board or extends along a perimeter of the light source circuit board.

15. The equipment according to claim 11, further comprising a driver circuit board and a light source circuitry board, wherein the near-field communication chip and the antenna are on different circuit boards.

16. A method of communicating with a pool light for a swimming pool or spa, wherein the method comprises at least one of sending information to the pool light or receiving information from the pool light at least while the pool light is not powered or functional.

17. The method of claim 16, wherein sending information to the pool light comprises powering the pool light by communicating with the pool light.

18. The method of claim 16, wherein communicating with the pool light comprises communicating using near-field communications.

19. The method of claim 16, wherein sending information to the pool light or receiving information from the pool light at least while the pool light is not powered or functional comprises using near-field communications to set a color mode on the pool light.

20. The method of claim 16, wherein communicating with the pool light comprises communicating using a piece of pool equipment.
